(19) United States
(12) Patent Application Publication
(10) Pub. No.: US 2024/0193430 A1
(43) Pub. Date: Jun. 13, 2024

(54) TECHNIQUE FOR CONFIGURING A REINFORCEMENT LEARNING AGENT

(71) Applicant: Telefonaktiebolaget LM Ericsson (publ), Stockholm (SE)

(72) Inventors: Ajay KATTEPUR, Bangalore (IN); Rafia INAM, Västerås (SE); Ahmad Ishtar TERRA, Sundbyberg (SE); Hassam RIAZ, Järfälla (SE); Alberto HATA, Barueri SP (BR); Prayag Gowgi SOMANAHALLI KRISHNA MURTHY, Mandya (IN)

(21) Appl. No.: 18/286,609

(22) PCT Filed: Apr. 13, 2021
(86) PCT No.: PCT/EP2021/059578

§ 371 Date: Oct. 12, 2023

(51) Int. Cl. G06N 3/092

(52) U.S. Cl. CPC G06N 3/092

(57) ABSTRACT

A technique for configuring a reinforcement learning agent to perform a task using a reward structure derived from a task-specific definition of metric importances is disclosed. A method is performed by a computing unit executing a configurator component and includes obtaining a definition of metric importances specifying, for a plurality of performance-related metrics associated with the task, pairwise importance values each indicating a relative importance of one metric with respect to another metric of the plurality of performance-related metrics for the task, deriving a reward structure from the definition of metric importances, the reward structure defining, for each of the plurality of performance-related metrics, a reward to be attributed to an action taken by the reinforcement learning agent that yields a positive outcome in the respective performance-related metric, and configuring the reinforcement learning agent to employ the derived reward structure when performing the task.

### TECHNICAL FIELD

The present disclosure generally relates to the field of machine learning. In particular, a technique for configuring a reinforcement learning agent to perform a task using a reward structure derived from a task-specific definition of metric importances is presented. The technique may be embodied in methods, computer programs, apparatuses and systems.

### BACKGROUND

In reinforcement learning, an agent may observe the environment and adapt itself to the environment with the aim of maximizing a total outcome. The agent may maintain a value for each possible state-action pair in the environment and, for a given state, the agent may choose the next action according to a state-to-action mapping function, e.g., as the action which provides the highest value in that state. As the agent explores the environment by taking different actions (e.g., through a trial-and-error process), the values of the state-action pairs may be iteratively updated based on positive or negative rewards attributed to a respective state-action pair depending on whether the action performed was desirable or not in the given state, wherein positive rewards may lead to higher values and negative rewards may lead to lower values for the given state-action pair.

Reinforcement learning algorithms may be modeled using Markov Decision Process (MDP) models, for example. An MDP is given by a tuple of (S, A, P, R), where S is the set of possible states, A is the set of actions, P (s, a, s′) is the probability that action a in state s will lead to state s′, and R (s, a, s′) is the reward for action a transitioning from state s to s′. Rewards are the principal inputs provided by stakeholders to establish the success/failure of a given state-action pair. In other words, rewards may be the human generated inputs provided to the reinforcement learning model. Rewards may be provided in the form of static values (e.g., +1, −1) attributed to corresponding state-action pairs, or in the form of reward functions. Rewards may be maximized using value or policy iteration algorithms, for example.

While reward engineering has traditionally been performed in a trial-and-error manner (e.g., setting −100 for an unwanted action), such approaches may lead to multiple problems, including (i) slight fluctuations in rewards at particular states deviating from given policies, (ii) inconsistent valuation of rewards, or (iii) inability to explain or gain feedback from users on the efficacy of the reward model, for example. Given a reinforcement learning agent and a supervisor of rewards (e.g., a stakeholder providing input), conventional ways of performing reward engineering include the following. (1) Direct supervision: The agent's behavior is directly observed by the supervisor with evaluations performed to optimize the behavior. This approach is challenging because the assumption is that the supervisor knows “everything” about the environment to evaluate actions. There can be biased or short-sighted attribution of rewards that may not be consistent over the long run. (2) Imitation learning: The supervisor solves the problem, e.g., with nuances of safety and avoiding states, wherein the solution is transcribed to the agent to replicate and reproduce. There are also complexities in this approach because the supervisor has to follow an action sequence that can be understood by the agent and, also, there is a restriction to the agent learning a novel reward space, as the actions are to be imitated. (3) Inverse reinforcement learning: In this approach, the agent tries to estimate the reward function from historical data. However, the assumption is that the problem has been solved previously, which may not always be the case.

In all these techniques, the subjectivity and consistency of rewards has not been explored in depth. However, as agents are increasingly deployed in complex environments with differing context and preferences, it is generally desirable to have more robust reward functions in place. If a reward function is “better behaved”, the reinforcement learning agent will generally perform better learning, which—in practice—may result in improved speed of convergence or in avoidance of undesired states, such as getting stuck in local minima, for example. As a mere example, while sparse reward functions are easier to define (e.g., get +1 if you win the game, else 0), sparse rewards also slow down learning because the agent needs to take many actions before getting any reward. Moreover, it is also generally difficult to capture the need for explainable actions or avoiding certain state sequences and, therefore, bringing in concepts, such as explainability and safe execution, normally further complicates the process.

### SUMMARY

Accordingly, there is a need for a technique for reward engineering which results in more consistent reward structures that enable improved reinforcement learning output and/or explainability.

According to a first aspect, a method for configuring a reinforcement learning agent to perform a task using a reward structure derived from a task-specific definition of metric importances is provided. The method is performed by a computing unit executing a configurator component and comprises obtaining a definition of metric importances specifying, for a plurality of performance-related metrics associated with the task, pairwise importance values each indicating a relative importance of one metric with respect to another metric of the plurality of performance-related metrics for the task. The method further comprises deriving a reward structure from the definition of metric importances. The reward structure defines, for each of the plurality of performance-related metrics, a reward to be attributed to an action taken by the reinforcement learning agent that yields a positive outcome in the respective performance-related metric. The method further comprises configuring the reinforcement learning agent to employ the derived reward structure when performing the task.

Deriving the reward structure from the definition of metric importances may be performed using a multi-criteria decision-making (MCDM) technique. The definition of metric importances may be provided as a matrix A:

$$\begin{matrix}\begin{matrix}{A}_{1} & ⋯ & {A}_{n}\end{matrix} \\ \begin{matrix}{A}_{1} \\ ⋮ \\ {A}_{n}\end{matrix} [ \begin{matrix}{w}_{11} & ⋯ & {w}_{1 n} \\ ⋮ & ⋱ & ⋮ \\ {w}_{n 1} & ⋯ & {w}_{nn}\end{matrix} ]\end{matrix}$$

where n may be the number of metrics of the plurality of performance-related metrics and wᵢⱼ may be the pairwise importance value indicating the relative importance of metric Aᵢ with respect to metric Aⱼ, where i=1, . . . , n and j=1, . . . , n.

Deriving the reward structure from the matrix A may include solving the eigenvalue problem Aw=λw:

$$[ \begin{matrix}{w}_{11} & ⋯ & {w}_{1 n} \\ ⋮ & ⋱ & ⋮ \\ {w}_{n 1} & ⋯ & {w}_{nn}\end{matrix} ] [ \begin{matrix}{w}_{1} \\ ⋮ \\ {w}_{n}\end{matrix} ] = λ [ \begin{matrix}{w}_{1} \\ ⋮ \\ {w}_{n}\end{matrix} ]$$

where λ may be the maximum eigenvalue of A and w=[w₁ . . . wₙ] may be the solution of the eigenvalue problem. Each weight wᵢ may then be taken as the reward for the corresponding metric Aᵢ, where i=1, . . . , n. w=[w₁ . . . wₙ] may be normalized by dividing each weight wᵢ by the sum of the weights w₁ . . . wₙ, where i=1, . . . , n. The matrix A may be a positive reciprocal matrix.

Deriving the reward structure from the matrix A may include performing a consistency check of the matrix A using, as a measure of deviation of the matrix A from consistency, an inconsistency value defined by:

$$\frac{λ - n}{n - 1}$$

If the inconsistency value is above a predefined threshold, deriving the reward structure from the matrix A may include identifying, among the pairwise importance values wᵢⱼ of the matrix A, one or more entries causing inconsistency and perturbing the one or more entries to reduce the inconsistency. Identifying and perturbing one or more entries causing inconsistency may be iteratively performed until the inconsistency value is below the predefined threshold. Alternatively, if the inconsistency value is above a predefined threshold, deriving the reward structure from the matrix A may include reconstructing the matrix A based on a set of distinct eigenvalues λ₁, . . . , λₙ and corresponding linearly independent eigenvectors v₁, . . . , vₙ. The matrix A may then be reconstructed as

A=PDP⁻¹

where matrix P may be constructed by stacking v₁, . . . , vₙ as column vectors and matrix D may be D=(λ₁, . . . , λₙ).

The definition of metric importances may be derived from a requirements specification regarding the task to be performed by the reinforcement learning agent. The requirements specification may be formulated using a formal requirements specification syntax, optionally an Easy Approach to Requirements Syntax (EARS). At least portions of the requirements specification may be pattern matched to derive the definition of metric importances. An explanation provided in response to a query requesting a reason why the reinforcement learning agent took a particular action (e.g., an explanation provided by an explainer component according to the third aspect below) may be provided on the basis of the derived reward structure. The explanation may be provided with reference to a formulation of the requirements specification, optionally indicating that the particular action was taken in order to meet the formulation of the requirements specification.

The reinforcement learning agent may be operable to perform the task in a plurality of deployment setups. For each of the plurality of deployment setups, a different definition of metric importances specific to the respective deployment setup may be obtained and used to derive a different reward structure specific to the respective deployment setup. The reinforcement learning agent may be configured to employ one of the different reward structures depending on the deployment setup in which the reinforcement learning agent currently operates. When an operation of the reinforcement learning agent is changed to a different deployment setup, the reinforcement learning agent may be automatically reconfigured to employ the different reward structure that corresponds to the different deployment setup.

In one variant, the task to be performed by the reinforcement learning agent may include determining a network slice configuration for a mobile communication network. The plurality of performance-related metrics may then comprise at least one of a latency observed for a network slice, a throughput observed for a network slice, an elasticity for reconfiguring a network slice, and an explainability regarding a reconfiguration of a network slice. In another variant, the task to be performed by the reinforcement learning agent may include operating a robot. The plurality of performance-related metrics may then comprise at least one of an energy consumption of the robot, a movement accuracy of the robot, a movement speed of the robot, and a safety level provided by the robot. In still another variant, the task to be performed by the reinforcement learning agent may include determining an antenna tilt configuration for one or more base stations of a mobile communication network. The plurality of performance-related metrics may then comprise at least one of a coverage achieved by the antenna tilt configuration, a capacity achieved by the antenna tilt configuration, and an interference level caused by the antenna tilt configuration. In yet another variant, the task to be performed by the reinforcement learning agent may include determining an offloading level for offloading of computational tasks of one computing device to one or more networked computing devices. The plurality of performance-related metrics may then comprise at least one of an energy consumption of the computing device, a latency observed by the computing device of receiving results of the computational tasks offloaded to the one or more networked computing devices, and a task accuracy achieved by the computing device when offloading the computational tasks to the one or more networked computing devices.

According to a second aspect, a method for configuring a reinforcement learning agent to perform a task using a reward structure derived from a task-specific definition of metric importances is provided. The method is performed by a computing unit executing the reinforcement learning agent and comprises applying a configuration (e.g., as received by a configurator component according to the first aspect) to the reinforcement learning agent to employ a derived reward structure when performing the task. The derived reward structure is derived from a definition of metric importances specifying, for a plurality of performance-related metrics associated with the task, pairwise importance values each indicating a relative importance of one metric with respect to another metric of the plurality of performance-related metrics for the task. The derived reward structure defines, for each of the plurality of performance-related metrics, a reward to be attributed to an action taken by the reinforcement learning agent that yields a positive outcome in the respective performance-related metric.

The method according to the second aspect may define a method from the perspective of a reinforcement learning agent described above in relation to the method according to the first aspect. As such, aspects described above with respect to the method of the first aspect may be comprised by the method of the second aspect as well (i.e., from the perspective of the reinforcement learning agent).

According to a third aspect, a method for explaining an action performed by a reinforcement learning agent performing a task using a reward structure derived from a task-specific definition of metric importances is provided. The method is performed by a computing unit executing an explainer component and comprises providing an explanation in response to a query requesting a reason why the reinforcement learning agent took the action on the basis of a derived reward structure. The derived reward structure is derived from a definition of metric importances specifying, for a plurality of performance-related metrics associated with the task, pairwise importance values each indicating a relative importance of one metric with respect to another metric of the plurality of performance-related metrics for the task. The derived reward structure defines, for each of the plurality of performance-related metrics, a reward to be attributed to an action taken by the reinforcement learning agent that yields a positive outcome in the respective performance-related metric.

The method according to the third aspect may define a method from the perspective of an explainer component described above in relation to the method according to the first aspect. As such, aspects described above with respect to the method of the first aspect may be comprised by the method of the third aspect as well (i.e., from the perspective of the explainer component).

According to a fourth aspect, a computer program product is provided. The computer program product comprises program code portions for performing the method of at least one of the first, the second and the third aspect when the computer program product is executed on one or more computing devices (e.g., a processor or a distributed set of processors). The computer program product may be stored on a computer readable recording medium, such as a semiconductor memory, DVD, CD-ROM, and so on.

According to a fifth aspect, a computing unit configured to execute a configurator component for configuring a reinforcement learning agent to perform a task using a reward structure derived from a task-specific definition of metric importances is provided. The computing unit comprises at least one processor and at least one memory, the at least one memory containing instructions executable by the at least one processor such that the configurator component is operable to perform any of the method steps presented herein with respect to the first aspect.

According to a sixth aspect, a computing unit configured to execute a reinforcement learning agent for configuring the reinforcement learning agent to perform a task using a reward structure derived from a task-specific definition of metric importances is provided. The computing unit comprises at least one processor and at least one memory, the at least one memory containing instructions executable by the at least one processor such that the reinforcement learning agent is operable to perform any of the method steps presented herein with respect to the second aspect.

According to a seventh aspect, a computing unit configured to execute an explainer component for explaining an action performed by a reinforcement learning agent performing a task using a reward structure derived from a task-specific definition of metric importances is provided. The computing unit comprises at least one processor and at least one memory, the at least one memory containing instructions executable by the at least one processor such that the explainer component is operable to perform any of the method steps presented herein with respect to the third aspect.

According to an eighth aspect, there is provided a system comprising a computing unit of the fifth aspect, a computing unit of the seventh aspect and, optionally, a computing unit of the sixth aspect.

### BRIEF DESCRIPTION OF THE DRAWINGS

Implementations of the technique presented herein are described herein below with reference to the accompanying drawings, in which:

FIGS. 1a to 1c illustrate exemplary compositions of a computing unit configured to execute a configurator component, a computing unit configured to execute a reinforcement learning agent, and a computing unit configured to execute an explainer component according to the present disclosure;

FIG. 2 illustrates a method which may be performed by the configurator component according to the present disclosure;

FIG. 3 illustrates a table defining exemplary relative importance intensity values according to the present disclosure;

FIG. 4 illustrates an iterative process of reducing inconsistencies according to the present disclosure to provide a reliable reward structure;

FIG. 5 illustrates an exemplary search space for consistent matrix generation using an optimization framework according to the present disclosure;

FIG. 6 illustrates an exemplary explanation tree that may be exposed to a stakeholder according to the present disclosure;

FIG. 7 illustrates an architectural overview of the technique presented herein;

FIGS. 8a and 8b illustrate a functional overview of the technique presented herein in the form of a signaling diagram;

FIG. 9 illustrates exemplary network slice reconfiguration use cases according to the present disclosure;

FIG. 10 illustrates exemplary deployment zones in a robot operation use case according to the present disclosure;

FIG. 11 illustrates an exemplary antenna tilt configuration use case according to the present disclosure;

FIG. 12 illustrates an exemplary task offloading use case according to the present disclosure;

FIG. 13 illustrates a method which may be performed by the reinforcement learning agent according to the present disclosure; and

FIG. 14 illustrates a method which may be performed by the explainer component according to the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

Those skilled in the art will further appreciate that the steps, services and functions explained herein below may be implemented using individual hardware circuitry, using software functioning in conjunction with a programmed micro-processor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

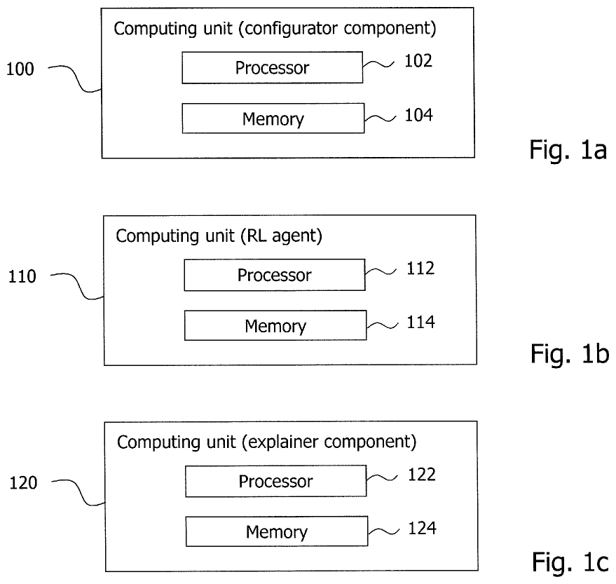

FIG. 1a schematically illustrates an exemplary composition of a computing unit 100 configured to execute a configurator component for configuring a reinforcement learning agent to perform a task using a reward structure derived from a task-specific definition of metric importances. The computing unit 100 comprises at least one processor 102 and at least one memory 104, wherein the at least one memory 104 contains instructions executable by the at least one processor 102 such that the configurator component is operable to carry out the method steps described herein below with reference to the configurator component.

FIG. 1b schematically illustrates an exemplary composition of a computing unit 110 configured to execute a reinforcement learning agent for configuring the reinforcement learning agent to perform a task using a reward structure derived from a task-specific definition of metric importances. The computing unit 110 comprises at least one processor 112 and at least one memory 114, wherein the at least one memory 114 contains instructions executable by the at least one processor 112 such that the reinforcement learning agent is operable to carry out the method steps described herein below with reference to the reinforcement learning agent.

FIG. 1c schematically illustrates an exemplary composition of a computing unit 120 configured to execute an explainer component for explaining an action performed by a reinforcement learning agent performing a task using a reward structure derived from a task-specific definition of metric importances. The computing unit 120 comprises at least one processor 122 and at least one memory 124, wherein the at least one memory 124 contains instructions executable by the at least one processor 122 such that the explainer component is operable to carry out the method steps described herein below with reference to the explainer component.

It will be understood that each of the computing unit 100, the computing unit 110 and the computing unit 120 may be implemented on a physical computing unit or a virtualized computing unit, such as a virtual machine, for example. It will further be appreciated that each of the computing unit 100, the computing unit 110 and the computing unit 120 may not necessarily be implemented on a standalone computing unit, but may be implemented as components—realized in software and/or hardware—residing on multiple distributed computing units as well, such as in a cloud computing environment, for example.

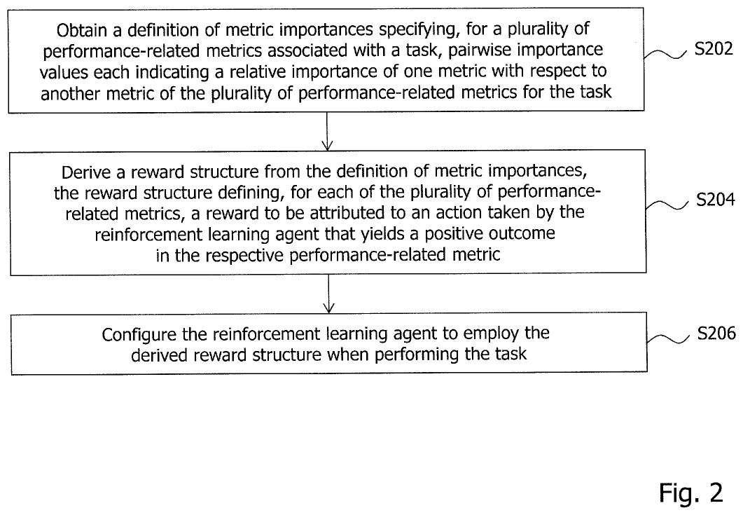

FIG. 2 illustrates a method which may be performed by the configurator component executed on the computing unit 100 according to the present disclosure. The method is dedicated to configuring a reinforcement learning agent (e.g., the reinforcement learning agent executed on the computing unit 110) to perform a task using a reward structure derived from a task-specific definition of metric importances. In step S202, the configurator component may obtain a definition of metric importances specifying, for a plurality of performance-related metrics associated with the task, pairwise importance values each indicating a relative importance of one metric with respect to another metric of the plurality of performance-related metrics for the task. In step S204, the configurator component may derive a reward structure from the definition of metric importances, the reward structure defining, for each of the plurality of performance-related metrics, a reward to be attributed to an action taken by the reinforcement learning agent that yields a positive outcome in the respective performance-related metric. In step S206, the configurator component may configure the reinforcement learning agent to employ the derived reward structure when performing the task.

Thus, instead of directly encoding agent rewards, such as in the form of static rewards or reward functions as described above for conventional reinforcement learning techniques, according to the technique presented herein, rewards may be determined based on relative importances (or “preferences”/“rankings”) of performance-related metrics associated with the task to be performed by the reinforcement learning agent. Herein below, such importances may in brief be denoted as task-specific “metric importances”. The metric importances may be defined as pairwise importance values each indicating a relative importance (for the task) of one metric with respect to another metric of the performance-related metrics. A stakeholder (e.g., an operator or user of the reinforcement learning agent) may thus provide a (subjective) definition of relative metric importances that are to be maintained (or that are “preferred” to be maintained) when executing the reinforcement learning agent. The reward structure to be employed by the reinforcement learning agent may then be derived from these relative importances, wherein the reward structure may define, for each of the plurality of performance-related metrics, a reward to be attributed to a corresponding state-action pair defined for the reinforcement learning agent. Such reward may be considered to be objectified and, therefore, the presented technique may be said to transform subjective metric-related relative preferences (e.g., as defined by a stakeholder) to an objective reward structure associated with principal features associated with the task (i.e., the performance-related metrics). In this way, a more consistent and un-biased reward formulation may be achieved.

The task performed by the reinforcement learning agent may be any task suitable to be performed by a conventional reinforcement learning agent (exemplary tasks will be specified further below) and the metric importances may be defined in a task-specific way, i.e., the performance-related metrics based on which the metric importances are defined may correspond to metrics that specifically relate to the task, such as key performance indicators (KPIs) associated with the task, for example. Once the reward structure is derived from the definition of the metric importances, the configurator component may configure the reinforcement learning agent to employ the derived reward structure. In one variant, the configurator component may provide the reward structure to the reinforcement learning agent in the form of a configuration, for example, and the configuration may then be applied at the reinforcement learning agent so that the reinforcement learning agent is configured to employ the reward structure when performing the task.

In order to derive the reward structure from the definition of metric importances, multi-criteria decision-making (MCDM) techniques (also known as multi-criteria decision analysis (MCDA) techniques) may be employed, e.g., to extract relative weights for multiple metrics. The rewards for the reward structure may then be calculated based on these weights. In one variant, the weights may be used as the rewards for the reward structure, for example. Deriving the reward structure from the definition of metric importances may thus be performed using an MCDM technique. As known to one of skill in the art, MCDM is a sub-discipline of operations research directed to evaluating multiple—potentially conflicting—criteria in decision-making, wherein decision options are evaluated based on different criteria, rather than on a single superior criterion. Typical MCDM techniques include the analytic hierarchy process (AHP), multi-objective optimization, goal programming, fuzzy steps and multi-attribute theory, for example.

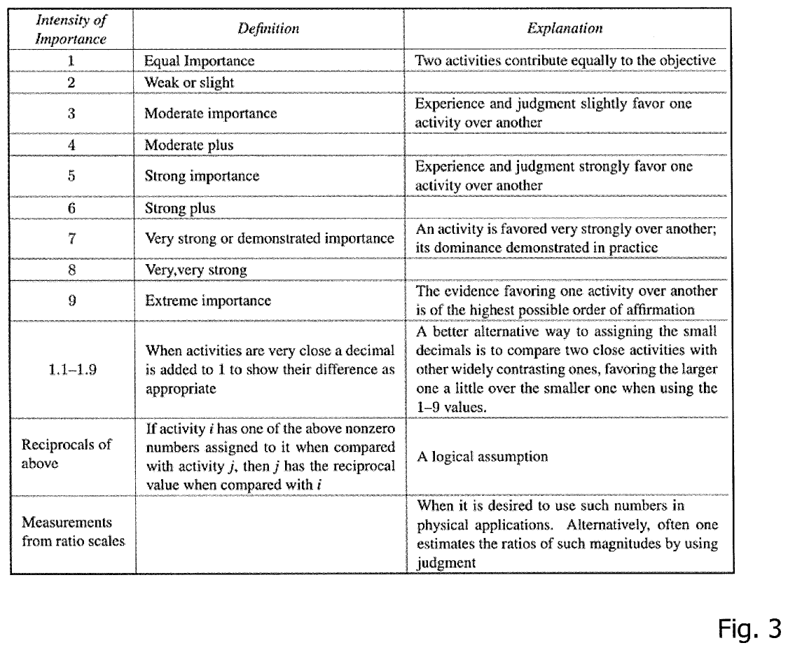

While it will be understood that various MCDM techniques may be employed to derive the reward structure from the definition of metric importances, such as one of the MCDM techniques mentioned above, a particular implementation for deriving the reward structure from the definition of metric importances—which may be considered to build upon AHP—will be described in the following. According to this implementation, the definition of metric importances may be provided as a matrix A:

$$\begin{matrix} \begin{matrix}{A}_{1} & ⋯ & {A}_{n}\end{matrix} \\ \begin{matrix}{A}_{1} \\ ⋮ \\ {A}_{n}\end{matrix} [ \begin{matrix}{w}_{11} & ⋯ & {w}_{1 n} \\ ⋮ & ⋱ & ⋮ \\ {w}_{n 1} & ⋯ & {w}_{nn}\end{matrix} ]\end{matrix}$$

where n may be the number of metrics of the plurality of performance-related metrics and wᵢⱼ may be the pairwise importance value indicating the relative importance of metric A; with respect to metric Aⱼ, where i=1, . . . , n and j=1, . . . , n. The pairwise importance values wᵢⱼ may indicate the preferences among the different available metrics. The preferences may be subjectively defined (e.g., by a stakeholder) on the basis of importance intensity values, such as the ones defined in the table of FIG. 3, for example. As shown in FIG. 3, importance values may be used to define the relative preference of one metric with respect to another. As a mere example, referring to the table of FIG. 3, an importance value of “1” may define an “equal importance” for a pair of metrics, meaning that each metric of the pair may contribute equally to an objective, and an importance value of “9” may define an “extreme importance” of one metric over another, meaning that one metric may be favored over another in the highest possible order. As another example, if a metric is of “strong importance” over another, the importance value may be “5” and, if a metric is slightly less important than another, it may be given the value “1/3” (reciprocal of “moderate importance” in the table). Based on such values, the pairwise importance values wᵢⱼ may be selected to express the relative importance of between all possible pairs of metrics Aᵢ and Aⱼ included in the matrix A.

An objective reward structure may then be derived by solving the eigenvalue problem Aw=Aw and extracting the values of w as rewards. Deriving the reward structure from the matrix A may thus include solving the eigenvalue problem Aw=λw:

$$[ \begin{matrix}{w}_{11} & ⋯ & {w}_{1 n} \\ ⋮ & ⋱ & ⋮ \\ {w}_{n 1} & ⋯ & {w}_{nn}\end{matrix} ] [ \begin{matrix}{w}_{1} \\ ⋮ \\ {w}_{n}\end{matrix} ] = λ [ \begin{matrix}{w}_{1} \\ ⋮ \\ {w}_{n}\end{matrix} ]$$

where λ may be the maximum eigenvalue of A and w=[w₁ . . . wₙ] may be the solution of the eigenvalue problem, wherein each weight wᵢ may be taken as the reward for the corresponding metric Aᵢ, where i=1, . . . , n. To make w unique, its entries may be normalized by dividing them by their sum. More precisely, w=[w₁ . . . wₙ] may be normalized by dividing each weight wᵢ by the sum of the weights w₁ . . . wₙ, where n.

In one particular variant, the matrix A may be a positive reciprocal matrix. A positive reciprocal matrix may provide ideal consistency with respect to the defined pairwise importance values. In case of a positive reciprocal matrix, the matrix A may have the form:

$$\begin{matrix}\begin{matrix}{A}_{1} & ⋯ & {A}_{n}\end{matrix} \\ \begin{matrix}{A}_{1} \\ ⋮ \\ {A}_{n}\end{matrix} [ \begin{matrix}\frac{{w}_{1}}{{w}_{1}} & ⋯ & \frac{{w}_{1}}{{w}_{n}} \\ ⋮ & ⋱ & ⋮ \\ \frac{{w}_{n}}{{w}_{1}} & ⋯ & \frac{{w}_{n}}{{w}_{n}}\end{matrix} ]\end{matrix}$$

Given n metrics with relative weight comparison, a positive reciprocal matrix A may thus be constructed using pairwise comparison between the metrics, wherein wᵢⱼ may be of the form

$${w}_{i j} = \frac{{w}_{i}}{{w}_{j}} ,$$

with

$$\frac{{w}_{i}}{{w}_{j}}$$

having a positive value. To extract the values of w in this case, the eigenvalue problem Aw=λw must be solved in the following form:

$$[ \begin{matrix}\frac{{w}_{1}}{{w}_{1}} & … & \frac{{w}_{1}}{{w}_{n}} \\ ⋮ & ⋱ & ⋮ \\ \frac{{w}_{n}}{{w}_{1}} & … & \frac{{w}_{n}}{{w}_{n}}\end{matrix} ] [ \begin{matrix}{w}_{1} \\ ⋮ \\ {w}_{n}\end{matrix} ] = λ [ \begin{matrix}{w}_{1} \\ ⋮ \\ {w}_{n}\end{matrix} ]$$

w may in this case correspond to a nonzero solution that consists of positive entries and may be unique within a multiplicative constant. To make w unique, the entries of w may be normalized by their sum, as described above.

Deriving the reward structure from the definition of metric importances may also include performing a consistency check in order to determine a measure of consistency of the pairwise importance values specified by the definition of metric importances. In case of the matrix A being a positive reciprocal matrix, the matrix A may have a maximum eigenvalue λ of λ≥n, wherein equality (λ=n) may only be given if A is consistent. Thus, as a measure of deviation of the matrix A from consistency, a value determined based on a relation between λ and n may be employed, such as a value

$$\frac{λ - n}{n - 1}$$

(represent an inconsistency value), for example. Deriving the reward structure from the matrix A may thus include performing a consistency check of the matrix A using, as a measure of deviation of the matrix A from consistency, an inconsistency value defined by:

$$\frac{λ - n}{n - 1}$$

The inconsistency value may be compared to a predefined threshold in order to determine whether the consistency of the pairwise importance values specified in the definition of metric importances is generally acceptable and the pairwise importance values may thus be considered to be suitable to obtain a sufficiently consistent and reliable reward structure. An inconsistency value of <0.1 may be acceptable, for example, wherein 0.1 represents the predefined threshold. In case of the matrix A being a positive reciprocal matrix, it is to be noted that negative rewards may not be seen and all rewards may be normalized within the [0, 1] range, as described above. This may allow for faster reinforcement learning convergence in diverse scenarios and also prevent the agent from converging on local minima.

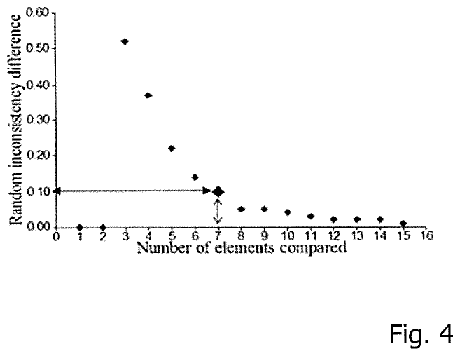

If the determined consistency of the pairwise importance values turns out to be inacceptable, countermeasures may be taken to increase consistency. In case of matrix A, inconsistent entries may be perturbed in order to increase consistency of the matrix A and thereby generate a more consistent reward structure. If the inconsistency value is above a predefined threshold, deriving the reward structure from the matrix A may thus include identifying, among the pairwise importance values wᵢⱼ of the matrix A, one or more entries causing inconsistency and perturbing the one or more entries to reduce the inconsistency. Such process may be repeatedly iterated until sufficient consistency is reached for a reliable reward function. An exemplary illustration of such iterative process is depicted in FIG. 4, which shows how the inconsistency may be reduced step by step over a number of iterations. Identifying and perturbing one or more entries causing inconsistency may thus be iteratively performed until the inconsistency value is below the predefined threshold.

While it will be understood that, in one variant, identifying and perturbing inconsistent entries may be performed by a stakeholder (manually) to refine the pairwise importance values in the definition of metric importances for the sake of improved consistency, in another variant, such process may also be performed as an automated process. As a mere example for such process of identifying and perturbing inconsistent entries, consider the following matrix A of pairwise importance values:

$$\begin{matrix}1 & 2 & 3 \\ 2 & 1 & 2 \\ 1 & 1 & 1\end{matrix}$$

In this case, the maximum eigenvalue λ is 4.44, producing an inconsistency value of (4.44−3)/(3−1)=0.72. As we know that an ideal consistency may be provided by a positive reciprocal matrix, the elements in the matrix may be reduced iteratively until the desired consistency level is reached. In the next iteration, some exemplary values below the diagonal of the matrix A may thus be reduced as follows:

$$\begin{matrix}1 & 2 & 3 \\ 1 & 1 & 2 \\ 0.5 & 1 & 1\end{matrix}$$

The maximum eigenvalue λ is then 3.71, producing an inconsistency value of (3.71−3)/(3−1)=0.355. In a further exemplary iteration, the values below the diagonal of the matrix A may be reduced as follows:

$$\begin{matrix}1 & 2 & 3 \\ 0.5 & 1 & 1 \\ 0.5 & 0.5 & 1\end{matrix}$$

The maximum eigenvalue λ is then 3.18, producing an inconsistency value of (3.18−3)/(3−1)=0.09, which may be considered to be acceptable (<0.1). If such iterative process is performed as an automated process, as described above, the resulting matrix (or, more generally, the resulting definition of metric importances) may then be sent to the stakeholder for approval or reconciliation, for example.

According to the above description, the procedure for computing the objective reward structure using subjective preferences of metrics may be performed based on computing the maximum eigenvalue and its corresponding eigenvector, wherein inconsistencies may be removed by iteratively identifying and perturbing entries causing inconsistency. In other variants, when the consistency of a given matrix A is insufficient, it may be conceivable to construct the matrix A with a given set of eigenvalues and eigenvectors. Such consistent matrix generation procedure may be used by the reinforcement learning agent, for example, to recommend a new matrix A to the stakeholder whenever consistency turns out to be insufficient. The construction of a matrix with given eigenvalue and eigenvectors may be based on a rank-one decomposition of a matrix and may be performed as follows.

Let λ₁, . . . ,n be the n distinct eigenvalues with v₁, . . . ,vₙ being the corresponding eigenvectors that are linearly independent. Then, define a matrix P by stacking v₁, . . . ,vₙ as column vectors of matrix P (this implies that P⁻¹ exists) and specify another matrix D=(λ₁, . . . ,λn). The matrix A may then be written as A=PDP⁻¹. Thus, in this variant, if the inconsistency value is above a predefined threshold, deriving the reward structure from the matrix A may include reconstructing the matrix A based on a set of distinct eigenvalues λ₁, . . . , λₙ and corresponding linearly independent eigenvectors v₁, . . . , vₙ, wherein the matrix A may be reconstructed as

A=PDP⁻¹

where matrix P may be constructed by stacking v₁, . . . , vₙ as column vectors and matrix D may be D=(λ₁, . . . , λₙ). In this variant, it is notable that only the maximum eigenvalue and eigenvector pair may be needed to compute the objective reward structure.

As a mere example for a decomposition according to this variant, consider the following exemplary matrices A, P and D:

$$\to A = [ \begin{matrix}1 & 2 & 3 ; & 2 & 1 & 2 ; & 1 & 1 & 1\end{matrix} ] \\ A = \\ \begin{matrix}1. & 2. & 3. \\ 2. & 1. & 2. \\ 1. & 1. & 1.\end{matrix}$$

$$\to [ P , D ] = schur ( A ) \\ P = \\ \begin{matrix}- 0.6882285 & - 0.6740874 & - 0.2682307 \\ - 0.6187033 & 0.7384162 & - 0.2682307 \\ - 0.3788769 & 0.0186488 & 0.9252592\end{matrix}$$

$$D = \\ \begin{matrix}4.4494897 & - 0.2682307 & - 2.1509197 \\ 0. & - 1. & - 0.5491781 \\ 0. & 0. & - 0.4494897\end{matrix}$$

Since, in this example, matrix A provides an inconsistent evaluation, matrix D is changed to produce a consistent version of matrix A:

$$\to D ( 1 ) = 3.1 \\ D = \begin{matrix}3.1 & - 0.2682307 & - 2.1509197 \\ 0. & - 1. & - 0.5491781 \\ 0. & 0. & - 0.4494897\end{matrix}$$

The matrix A may then be determined as

$$A = P D {P}^{- 1} = \begin{matrix}1 & 1.169 & 2.49 \\ 1.17 & 1 & 1.54 \\ 0.49 & 0.54 & 1\end{matrix}$$

The maximum eigenvalue λ is in this case 3.13, producing an inconsistency value of (3.13−3)/(3−1)=0.065.

Another view on generating a consistent matrix A may be based on an optimization framework. In this case, the eigenvalue λ may be defined in terms of the eigenvector and the matrix A and the objective may be to minimize the distance between the maximum eigenvalue and n, leading to a fully consistent matrix A. A corresponding minimization problem which introduces constraints on the off-diagonal entries as well as unit entries on the diagonal may be formulated as follows.
Let A be a matrix with (λ, x) eigen-pair. Finding a matrix A such that consistency condition is satisfied is to solve the following optimization problem

$$\begin{matrix}{min}_{A , x} {( {max}_{A , x} ( \frac{{x}^{T} A x}{{x}^{T} x} ) - n )}^{2} \\ s . t . {x}_{1}^{2} + … + {x}_{d}^{2} = 1 \\ {a}_{i , j} = \frac{1}{{a}_{j , i}} for all i , j = 1 , … , n \\ {a}_{i , i} = 1 for all i = 1 , … , n\end{matrix} \qquad ( 1 )$$

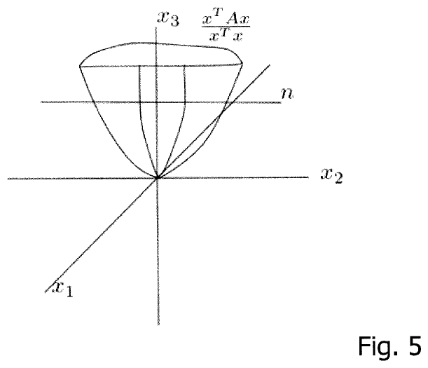

By setting an eigenvector x, a matrix A that solves the above problem can be generated, wherein a solution may be found with a conventional optimization constraint solver, for example. An example of the corresponding search space is depicted in FIG. 5 for illustrative purposes.

As is apparent from the above, before the reward structure may be derived from the definition of metric importances in accordance with one of the variants described above, the definition of metric importances and the corresponding pairwise importance values indicating the relative importance of one metric to another may be obtained. As said, one way of doing this may involve defining corresponding subjective preferences (e.g., by a stakeholder), e.g., on the basis of importance intensity values, such as the ones defined in the table of FIG. 3, for example. More generally, the definition of metric importances may be derived from a requirements specification regarding the task to be performed by the reinforcement learning agent. The requirements specification may be generated as part of a requirements elicitation process (e.g., performed at the side of the stakeholder) directed to eliciting the relative preferences of the performance-related metrics associated with the task. In one variant, the requirements specification may be formulated using a formal requirements specification syntax, optionally an Easy Approach to Requirements Syntax (EARS), wherein at least portions of the requirements specification may be pattern matched to derive the definition of metric importances. EARS is generally known to significantly reduce or eliminate problems typically associated with natural language (NL) requirement definitions, which is achieved by providing support for a number of particular requirement types, including the following:
Ubiquitous requirement: This type of requirement may be considered to be always active within a system. The following template may generate a ubiquitous requirement: “The <system name> shall <system response>”.
State-driven requirement: State-driven requirements may be active throughout the time that a defined state in the environment remains true. The following template may generate a state-driven requirement: “WHILE <in a specific state> the <system name> shall <system response>”.
Event-driven requirement: Event-driven requirements may require a response only when an event is detected in the environment. The following template may generate an event-driven requirement: “WHEN <trigger> the <system name> shall <system response>”.
Optional feature requirement: Optional feature requirements may apply only when an optional feature is present as a part of the system. The following template may generate an optional feature requirement: “WHERE <feature is included> the <system name> shall <system response>”.
Unwanted behaviour requirement: Unwanted behaviour requirements may be understood as a general term to cover all undesirable situations. The following template may generate an unwanted behaviour requirement: “IF <trigger>, THEN the <system name> shall <system response>”.

In the context of the particular task to be performed by the reinforcement learning agent, the requirements specification may be formulated using such templates. The requirements of the specification may be formulated using phrases that indicate relative importance values of one metric with respect to another, such as the importance intensity values defined in the table of FIG. 3, for example. As a mere example, a stakeholder may provide the following requirements in relation to a robotics use case:
a. The <robotic system> shall <complete the task with latency limits having “high importance”>
b. WHEN <in proximity of humans> the <robotic system> shall <maintain safety requirements with “extreme importance”>
c. WHILE <in task planning mode> the <robotic system> shall <produce plans with explanations treated as “high importance”>

As said, at least portions of the requirements specification may be pattern matched to derive the definition of metric importances. The above requirements or requirement templates may thus be pattern matched to produce a comparison table for the subjective preferences, which may be transformed into the matrix A, as one possible representation of the definition of metric importances. Given the subjective evaluations of the various metrics, the objective reward structure may then be derived, optionally including the consistency evaluation to make sure the metrics are evaluated in a consistent manner, as described above.

Once the reinforcement learning agent is configured to employ the derived reward structure, as described above, the agent may perform the task and, while doing so, effectively employ the derived reward structure. For explainability purposes, queries may be made so as to provide reasons why the reinforcement learning agent took particular actions. Corresponding explanations may then be provided on the basis of the derived reward structure and, as a result of the consistent reward engineering, the explanations provided may have improved explainability characteristics. An explanation provided in response to a query requesting a reason why the reinforcement learning agent took a particular action may thus be provided on the basis of the derived reward structure. The explanations may be provided by an explainer component in response to corresponding queries.

Like requirements, also queries may be formulated on the basis of templates using a formal specification syntax. Query templates may comprise templates of a contrastive form, such as of the form “why A rather than B?”, for example, where A may be the fact (the actual action taken by the agent, i.e., the agent output) and B may be the foil (e.g., a hypothetical alternative, such as expected by the stakeholder, for example). Exemplary query templates may be as follows:
“Why is action A used in the output, rather than not being used?” This constraint may enquire why the action A is being used in the output.
“Why is action A not used in the output, rather than being used?” This constraint may recommend that the action A is applied at some point in the output.
“Why is action A used, rather than action B?” This constraint may be considered as a combination of the previous two, recommending that the output include action B and not action A.
“Why is action A used before/after action B (rather than after/before)?” This constraint may recommend that, if action A is used, action B must appear earlier/later in the output.

For improved explainability, answers to such queries may be linked back to the requirements specification so that, based on the consistent reward structure, explanations may be composed in a way that exposes the requirements in a meaningful manner. In particular, the explanations may link the reward structure requirements and actions taken by the reinforcement learning agent. An explanation may thus be provided with reference to a formulation of the requirements specification, optionally indicating that the particular action was taken in order to meet the formulation of the requirements specification. As mere examples, the following explanations could be given in response to queries with reference to an exemplary robotics use case:
a. Why was <path 1> used rather than <path 2>:
   Explanation: Action <path 1> used rather than <path 2> to meet requirement—WHEN <in proximity of humans> the <robotic system> shall <maintain safety requirements with “extreme importance”>
b. Why was <path 1> used rather than not:
   Explanation: Action <path 1> used rather than not to meet requirement—WHILE <in single robot mode> the <robotic system> shall <maintain battery capacity with “high importance”>
c. Why was <action with KPI 1> used rather than <action with KPI 2>:
   Explanation: Action <action with KPI 1> used rather than <action with KPI 2> to meet requirement—WHEN <in human proximity> the <robotic system> shall <maintain safety with “extreme importance” over speed with “high importance”>

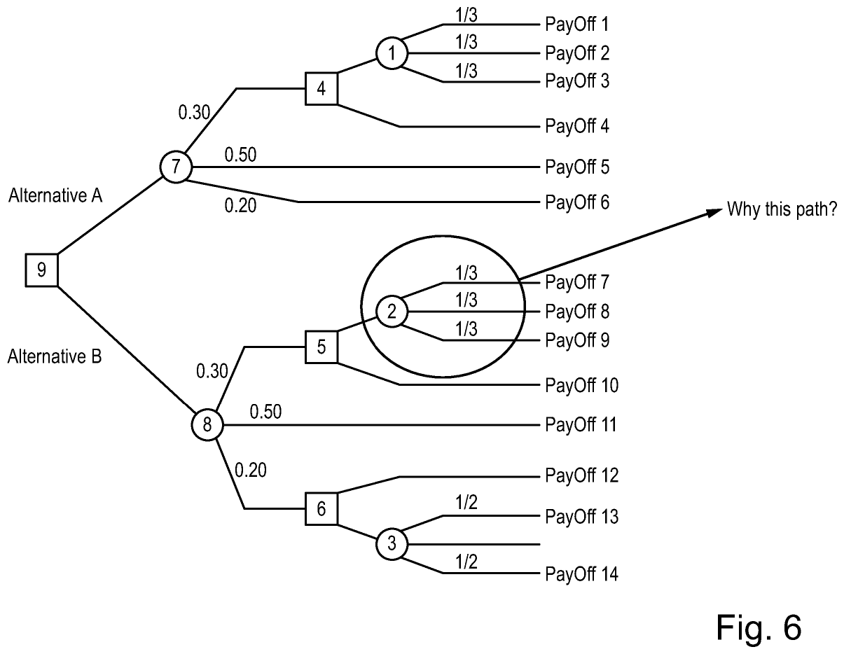

It will be understood that explanations concerning the output of the reinforcement learning agent (e.g., the actions taken by the agent) may also be created in the form of policy graphs or decision trees, for example. For decision trees (or “explanation trees”), explanations may particularly be provided on questions raised on the reason for a particular action, KPI level or path, for example. In order to generalize the type of explanation, the decision tree formalism may be made use of, wherein the tree to N levels prior to the current action may present the sets of believes, possible states, KPIs and objective functions that expose the reasoning behind the current decisions. FIG. 6 illustrates an exemplary explanation tree as it may be exposed to a stakeholder, for example.

In view of the above, it will be understood that, by the consistent reward structure obtained according to the technique presented herein, not only improvements in reinforcement learning agent output performance may be achieved, but also improved explainability. Subjective rewards may be transformed into an objective reward structure in a consistent manner, and such consistency may support the reinforcement learning agent's explainability, generally resulting in a higher probability of better explainable actions. Since explanations may be based on relative importance definitions provided by the stakeholder, the objective rewards may be converted back into the subjective criteria provided by the user, which may be a common touch point for consistent explanations. Improved explainability may generally be measured with respect to the following metrics:
Comprehensibility: How much effort is needed for a human to interpret it? As consistent rewards taken from stakeholder's inputs may be used, explanations according to the technique presented herein may be more comprehensible.
Actionability: How actionable is the explanation? What can you do with it? Explanations according to the technique presented herein may be directly actionable as they may be based on the consistent rewards generated. The actions may be changing the specific zones or relative importance of metrics in each zone (tweaking the reward structure; more details on zones will be provided further below).
Reusability: Can the explanation be interpreted/reused by another artificial intelligence (AI) system? The system of explanations presented herein may be transformed to relative importance structure that may generally be reused.
Accuracy: How accurate is the explanation? As an explanation according to the technique presented herein may be based on a consistent transformation of rewards with respect to zones, the explanation may be more accurate.
Completeness: Does the “explanation” explain the decision completely, or only partially? Explanations according to the technique presented herein may provide inputs of actions relative to all actions and zones over which the agent would operate—which may provide more complete explanations.

When the reinforcement learning agent is executed, the agent may perform its tasks in different deployment setups (or “zones”). Different deployment zones may be defined (e.g., by stakeholders) according to at least one of spatial, temporal and logical subdivisions and, in each deployment zone, the definition of the metric importances may differ. In other words, as different zones may have different characteristics necessitating different requirements regarding the reward structure, different reward structures, each specifically adapted to the respective zone, may be obtained (each reward structure may be obtained in accordance with the technique described above). For each deployment zone, a different consistent reward structure may thus be generated. The reinforcement learning agent may then be dynamically configured to employ the respective reward structure depending on the zone in which the reinforcement learning agent currently operates. The reinforcement learning agent may thus be operable to perform the task in a plurality of deployment setups, wherein, for each of the plurality of deployment setups, a different definition of metric importances specific to the respective deployment setup may be obtained and used to derive a different reward structure specific to the respective deployment setup, wherein the reinforcement learning agent may be configured to employ one of the different reward structures depending on the deployment setup in which the reinforcement learning agent currently operates.

Based on such support of different deployment zones, the reinforcement learning agent may be configured for automatic switching between the zones, i.e., in other words, when an operation of the reinforcement learning agent is changed to a different deployment setup, the reinforcement learning agent may be automatically reconfigured to employ the different reward structure that corresponds to the different deployment setup. During the deployment phase, optimal policies may be executed by the agents, which may have appropriate consistent reward structures in place for the corresponding zones. There may be no need for any human intervention since, for zones of importance, consistent reward structures may have already been captured. It is noted in this regard that explicit zones may now be weaved into the reinforcement learning agent policy due to the training in different zones with consistent reward hierarchies. Also, any explanations or feedback needed on the agent execution may be linked back to the consistent reward structure and definition of metric importances for the individual zones. If the agent explanations are unsatisfactory, it may also be conceivable to change the reward structure appropriately.

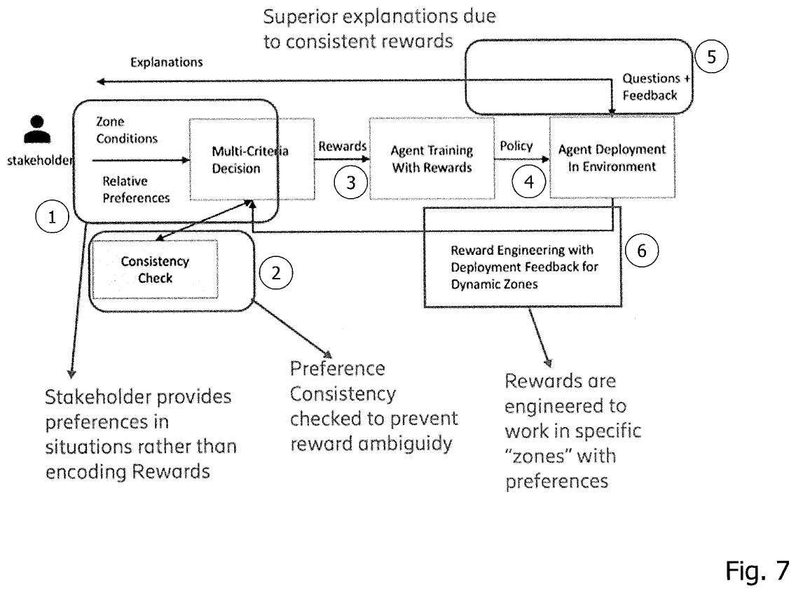

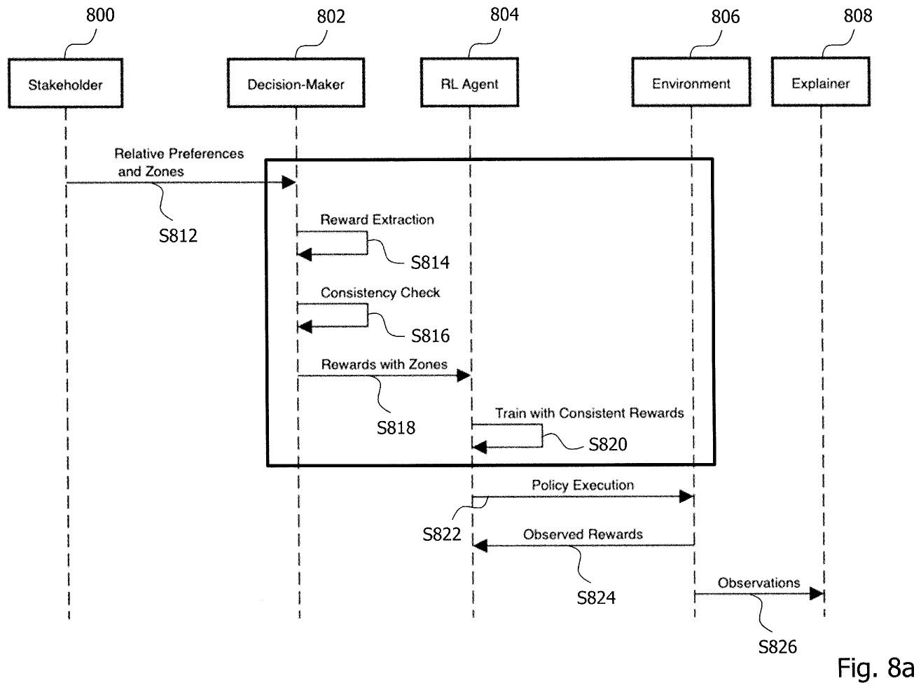

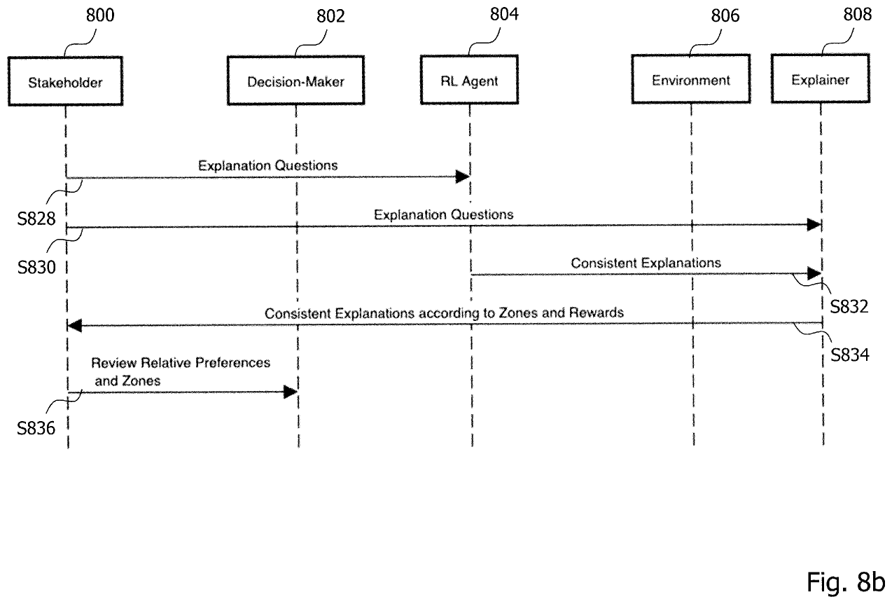

FIG. 7 and FIGS. 8a and 8b provide conceptual overviews summarizing the technique presented herein in a more illustrative manner, wherein FIG. 7 provides an architectural overview of the technique presented herein and FIGS. 8a and 8b provide a functional overview of the technique presented herein in the form of a signaling diagram of an exemplary embodiment. In the following, reference will be made to FIGS. 7, 8a and 8b in parallel. As indicated at box (1) in FIG. 7 and steps S812 and S814 in FIG. 8, a stakeholder 800 may provide subjective preferences for specific situations/use cases to a configurator component 802 (denoted in the figure as “decision-maker”), rather than encoding rewards directly as described above for conventional reinforcement learning techniques. Preferences may be provided as relative preferences between multiple metrics to enable making multi-criteria decision analyses by the configurator component 802 to derive (or “extract”) a reward structure. Zone-specific conditions may be considered when deriving reward structures for respective zones. As indicated at box (2) in FIG. 7 and step S816 of FIG. 8, a consistency check on the preferences may be made by the configurator component 802 to prevent ambiguity in the derived reward structure and make the reward structure consistent. At boxes (3) and (4) in FIG. 7 and steps S818, S820 and S822 in FIG. 8, the derived reward structure may be provided to the reinforcement learning agent 804 to configure (“train”) the reinforcement learning agent 804 to employ the derived reward structure when being executed (“deployed”) in the environment 806 to perform its actual task. As indicated at steps S824 and S826 in FIG. 8, when the reinforcement learning agent 804 is executed in the environment 806, observations regarding the reinforcement learning agent 804 may be gathered, such as by the reinforcement learning agent 804 and an explainer component 808, for example.

As indicated at box (5) in FIG. 7 and steps S828, S830, S832 and S834 in FIG. 8, questions may be posed by the stakeholder 800 to the reinforcement learning agent 804 and the explainer component 808 to obtain explanations and feedback on the actions actually taken by the reinforcement learning agent 804 in the environment 806. Based on input provided from the reinforcement learning agent 804, the explainer component 808 may then provide consistent explanations linked to the reward structure to the stakeholder 800. These explanations may provide a superior level of explainability due to the consistent reward structure. As indicated in step S836 in FIG. 8, the stakeholder 800 may then use these consistent explanations to review and possibly adapt the preferences that have been communicated to the configurator component 802 in order to refine the reward structure. Alternatively, as indicated in box (6) in FIG. 7, when the reinforcement learning agent 804 is executed in the environment 806, the reinforcement learning agent 804 may provide feedback depending on the zone it is currently operating in to the configurator component 802 for further reward engineering in order to refine reward structure according to the preferences for a particular zone, for example. Generally, it will be understood that the steps illustrated by boxes (1) to (6) in FIG. 7 may be performed iteratively. This may be crucial for safety-critical scenarios that require high quality explanations and where small deviations in subjective rewards may lead to alternate policies, for example.

In the following, exemplary tasks that may be performed by the reinforcement learning agent presented herein will be described to exemplify possible use cases of the technique presented herein.

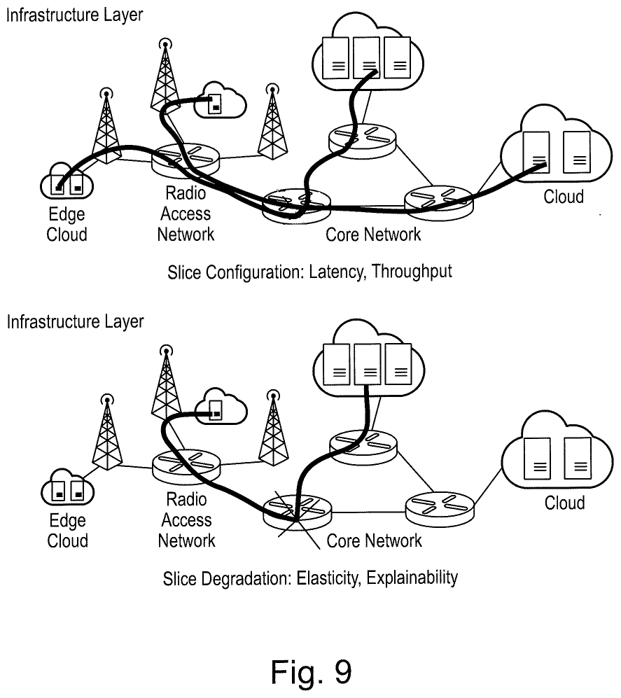

A first exemplary task relates to determining a network slice configuration for a mobile communication network, as it may occur in slice reconfiguration under varying conditions in a 5G network, for example. For 5G slicing, the reinforcement learning agent may determine an appropriate slice configuration to configure the network. As shown in FIG. 9, different use cases may be conceivable in such a setup, including the case of a slice configuration and the case of a slice degradation, wherein each such case may have different preferences regarding the reward structure. During the slice configuration process, the reinforcement learning agent may put preference on optimizing latency and throughput observed for each slice, whereas, during slice degradation (e.g., service level agreement (SLA) violation), elasticity in the reconfiguration as well as safety/explanations provided to the stakeholders may be more important metrics. The task to be performed by the reinforcement learning agent may thus include determining a network slice configuration for a mobile communication network. The plurality of performance-related metrics may in this case comprise at least one of a latency observed for a network slice, a throughput observed for a network slice, an elasticity for reconfiguring a network slice, and an explainability regarding a reconfiguration of a network slice.

As a mere example, preferences in the slice configuration use case may be reflected by the following matrix A.

### Slice Configuration:

| | Latency | Throughput | Elasticity | Safety |
|---|---|---|---|---|
| Latency | 1 | 1 | 5 | 3 |
| Throughput | 1 | 1 | 5 | 3 |
| Elasticity | ⅕ | ⅕ | 1 | ½ |
| Safety | ⅓ | ⅓ | 2 | 1 |

In this example, the following values apply:
Maximum eigenvalue λ: 4.004
Eigenvector: [0.68 0.68 0.13 0.23]
Normalized rewards=[0.68 0.68 0.13 0.23]/sum([0.68 0.68 0.13 0.23])
   Eigenvector corresponding to the maximum eigenvalue λ

| | Eigenvectors | Normalized Rewards |
|---|---|---|
| Latency | 0.68 | 0.39 |
| Throughput | 0.68 | 0.39 |
| Elasticity | 0.13 | 0.08 |
| Safety | 0.23 | 0.13 |

The inconsistency value is (4.004−4)/(4−1)=0.001 (<0.1).

In the above example, the rewards are consistently derived for the slice configuration. In case of deviations that require changes in a degraded slice, on the other hand, these rewards may be replaced by an alternative reward structure that emphasizes reconfiguration. This is exemplarily reflected by the following exemplary matrix A.

### Slice Degradation:

| | Latency | Throughput | Elasticity | Safety |
|---|---|---|---|---|
| Latency | 1 | 1 | ½ | ½ |
| Throughput | 1 | 1 | ½ | ½ |
| Elasticity | 2 | 2 | 1 | 1 |
| Safety | 2 | 2 | 1 | 1 |

In this example, the following values apply:
Maximum eigenvalue λ: 4
Eigenvector: [0.32 0.32 0.63 0.63]
Normalized rewards: [0.32 0.32 0.63 0.63]/sum([0.32 0.32 0.63 0.63])
Eigenvector corresponding to the maximum eigenvalue λ

| | Eigenvectors | Normalized Rewards |
|---|---|---|
| Latency | 0.32 | 0.16 |
| Throughput | 0.32 | 0.16 |
| Elasticity | 0.63 | 0.33 |
| Safety | 0.63 | 0.33 |

The inconsistency value is (4−4)/(4−1)=0 (<0.1)

It will be understood that, compared to the above two use cases, more complex deployments can have tens of such metrics to be monitored and reconfigured. Providing the technique described herein to rank and evaluate the metrics in a consistent manner may then become even more crucial.

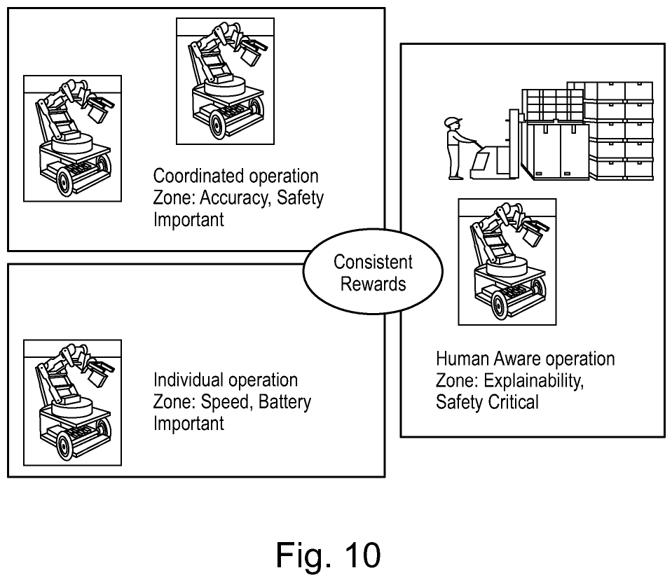

A second exemplary task that may be performed by the reinforcement learning agent presented herein relates to a robot that may operate in multiple deployment zones. More specifically, the robot may operate in areas with individual operation, areas near humans requiring explainable decisions and high accuracy areas when dealing with other robots. There may be a need to specify these features and requirements in a consistent manner such that rewards translate well to all situations. Exemplary zones are depicted in FIG. 10 and may include a coordinated operation zone with multiple robots having a metric preference on accuracy and safety, an individual operation zone for a single robot having a metric preference on speed and battery, and a human aware operation zone having a metric preference on explainability. The task to be performed by the reinforcement learning agent may thus include operating a robot. The plurality of performance-related metrics may in this case comprise at least one of an energy consumption of the robot, a movement accuracy of the robot, a movement speed of the robot, and a safety level provided by the robot.

As a mere example, a speed centric reward model may be reflected by the following exemplary matrix A.

### Speed Centric Reward Model:

| | Battery | Accuracy | Speed | Safety |
|---|---|---|---|---|
| Battery | 1 | 1 | ½ | 1 |
| Accuracy | 1 | 1 | ⅓ | 1 |
| Speed | 2 | 3 | 1 | 2 |
| Safety | 1 | 1 | ½ | 1 |

In this example, the following values apply:
Maximum eigenvalue λ: 4.0079
Eigenvector: [0.36 0.32 0.79 0.36]
Normalized rewards: [0.36 0.32 0.79 0.36]/sum([0.36 0.32 0.79 0.36])

### Eigenvector Corresponding to the Maximum Eigenvalue λ

| | Eigenvectors | Normalized Rewards |
|---|---|---|
| Battery | 0.36 | 0.19 |
| Accuracy | 0.32 | 0.17 |
| Speed | 0.79 | 0.43 |
| Safety | 0.36 | 0.19 |

The inconsistency value is (4.0079−4)/(4−1)=0.0026 (<0.1)

In the speed centric reward model, the highest weight may be provided to speed since other metrics, such as battery and accuracy, may be deemed to have less global effects on the task. When the same agent switches zones to human proximity, the weights may be reconfigured automatically (e.g., after consistency check) to a level where explainability is given higher preference, as exemplarily shown in the following matrix A.

### Explainability Centric Reward Model:

| | Battery | Accuracy | Speed | Safety |
|---|---|---|---|---|
| Battery | 1 | ⅓ | ⅓ | 1/7 |
| Accuracy | 3 | 1 | 1 | ⅓ |
| Speed | 3 | 1 | 1 | ⅓ |
| Safety | 7 | 3 | 3 | 1 |

In this example, the following values apply:
Maximum eigenvalue λ: 4.0079
Eigenvector: [0.11 0.31 0.31 0.89]
Normalized rewards: [0.11 0.31 0.31 0.89]/sum([0.11 0.31 0.31 0.89])

### Eigenvector Corresponding to the Maximum Eigenvalue λ

| | Eigenvectors | Normalized Rewards |
|---|---|---|
| Battery | 0.11 | 0.07 |
| Accuracy | 0.31 | 0.19 |
| Speed | 0.31 | 0.19 |
| Safety | 0.89 | 0.55 |

The inconsistency value is in this case 0.0026 (<0.1)

Thus, rather than making use of only one reward function, the switching between zones may allow for flexible and consistent change in weights for multiple zones.

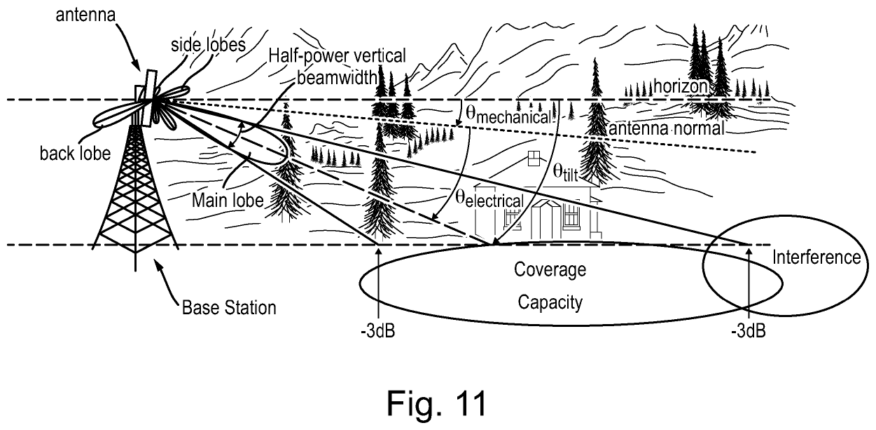

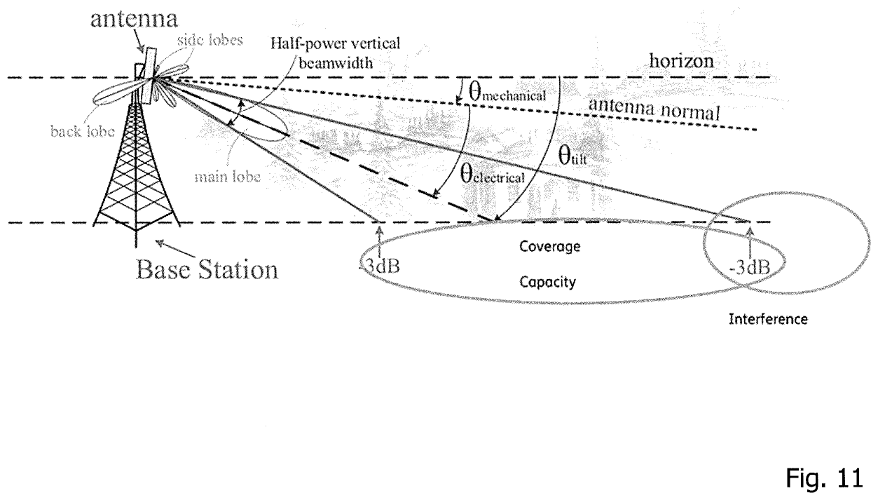

A third exemplary task that may be performed by the reinforcement learning agent presented herein relates to base stations of the mobile communication systems, where the angle of the antenna tilt may determine the power levels received by user equipment distributed in the cells. There may be a tradeoff between the coverage and capacity (throughput, Quality of Experience (QoE)) experienced by individual users. The tilting may be done by mechanically shifting the antenna angle or via electrical means (changing the power signal, lobe shaping), which may have to be optimized to prevent inter-cell interference, for example. In cases where higher specific capacity (e.g., HD video streaming, emergency broadcast) is needed, the coverage may be reduced. Such scenario is exemplarily depicted in FIG. 11. Accordingly, the task to be performed by the reinforcement learning agent may include determining an antenna tilt configuration for one or more base stations of a mobile communication network. The plurality of performance-related metrics may in this case comprise at least one of a coverage achieved by the antenna tilt configuration, a capacity achieved by the antenna tilt configuration, and an interference level caused by the antenna tilt configuration.

As a mere example, a coverage optimization model may be reflected by the following exemplary matrix A.

### Coverage Optimization:

| | Coverage | Capacity | Interference |
|---|---|---|---|
| Coverage | 1 | 3 | 1 |
| Capacity | ⅓ | 1 | 1 |
| Interference | 1 | 1 | 1 |

In this example, the following values apply:
Maximum eigenvalue λ: 3.1356108
Eigenvector: [0.764 0.367 0.53]
Normalized rewards: [0.764 0.367 0.53]/sum[0.764 0.367 0.53]
   Eigenvector corresponding to the maximum eigenvalue λ

| | Eigenvectors | Normalized Rewards |
|---|---|---|
| Coverage | 0.764 | 0.46 |
| Capacity | 0.367 | 0.22 |
| Interference | 0.53 | 0.32 |

The inconsistency value is (3.13−3)/(3−1)=0.065 (<0.1)

The above example shows the reward weights provided to the agent when coverage is the metric to be optimized. Reconfigured rewards may then be provided in a zone where some users are provided priority with increased capacity. The system may then have to reconfigure to reduce coverage while improving on the capacity aspect. This is exemplarily reflected by the following exemplary matrix A.

### Capacity Improvement:

| | Coverage | Capacity | Interference |
|---|---|---|---|
| Coverage | 1 | ⅕ | 1 |
| Capacity | 5 | 1 | 2 |
| Interference | 1 | ½ | 1 |

In this example, the following values apply:
Maximum eigenvalue λ: 3.09
Eigenvector: [0.246 0.9 0.33]
Normalized rewards: [0.246 0.9 0.33]/sum[0.246 0.9 0.33]
   Eigenvector corresponding to the maximum eigenvalue λ

| | Eigenvectors | Normalized Rewards |
|---|---|---|
| Coverage | 0.246 | 0.17 |
| Capacity | 0.9 | 0.61 |
| Interference | 0.33 | 0.22 |

The inconsistency value is (3.09−3)/(3−1)=0.045 (<0.1)

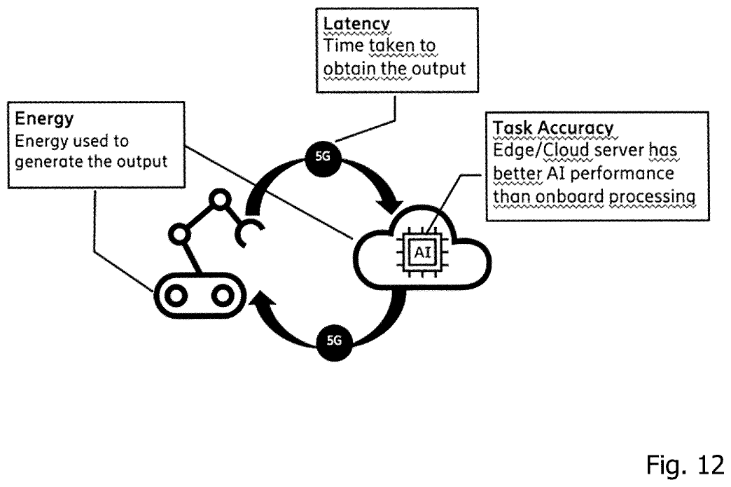

A fourth exemplary task that may be performed by the reinforcement learning agent relates to task offloading use cases. A simple device may have limited computation power to execute a heavy task. A heavy task may then be offloaded to a nearby device or a cloud device located far away. Besides having more computational power, such remote devices may also reduce the energy consumption of the simple device. Transferring data to the remote device may increase the latency if not compensated by the faster processing on the external device. A reinforcement learning agent may be implemented to decide whether the task is computed locally (on the simple device processor) or by a remote device, for example. Such scenario is exemplarily depicted in FIG. 12 in the context of a cloud robotics system. Accordingly, the task to be performed by the reinforcement learning agent may include determining an offloading level for offloading of computational tasks of one computing device to one or more networked computing devices. The plurality of performance-related metrics may in this case comprise at least one of an energy consumption of the computing device, a latency observed by the computing device of receiving results of the computational tasks offloaded to the one or more networked computing devices, and a task accuracy achieved by the computing device when offloading the computational tasks to the one or more networked computing devices.

In certain situations, energy consumption may have to be minimized as much as possible, so that the reward regarding energy may be prioritized over other factors. This is exemplarily reflected by the following exemplary matrix A.

### Energy Optimization:

| | Energy | Latency | Task Accuracy |
|---|---|---|---|
| Energy | 1 | 3 | 3 |
| Latency | ⅓ | 1 | 1 |
| Task Accuracy | ⅓ | 1 | 1 |

In this example, the following values apply:
Maximum eigenvalue λ: 3.0
Eigenvector: [0.905 0.302 0.302]
Normalized rewards: [0.905 0.302 0.302]/sum[0.905 0.302 0.302]
   Eigenvector corresponding to the maximum eigenvalue λ

| | Eigenvectors | Normalized Rewards |
|---|---|---|
| Energy | 0.905 | 0.6 |
| Latency | 0.302 | 0.2 |
| Task Accuracy | 0.302 | 0.2 |

The inconsistency value is (3.0−3)/(3−1)=0.0 (<0.1)

The above example shows the reward weights provided to the agent when the energy is the metric to be optimized. In a congested network, transferring data may take more time than usual. Thus, in such a case, obtaining faster output may be prioritized, which is exemplarily reflected by the following exemplary matrix A.

### Latency Optimization:

| | Energy | Latency | Task Accuracy |
|---|---|---|---|
| Energy | 1 | ½ | 1 |
| Latency | 2 | 1 | 1 |
| Task Accuracy | 1 | 1 | 1 |

In this example, the following values apply:
Maximum eigenvalue λ: 3.054
Eigenvector: [0.442 0.702 0.557]
Normalized rewards: [0.442 0.702 0.557]/sum[0.442 0.702 0.557]
   Eigenvector corresponding to the maximum eigenvalue λ

| | Eigenvectors | Normalized Rewards |
|---|---|---|
| Energy | 0.442 | 0.26 |
| Latency | 0.702 | 0.412 |
| Task Accuracy | 0.557 | 0.328 |

The inconsistency value is (3.054−3)/(3−1)=0.027 (<0.1)

The above case shows the reward weights provided to the agent when the latency is the metric to be optimized. In a critical application, it may be important to deliver an accurate output. In this case, latency may also be an important factor to execute the task. This is exemplarily reflected by the following exemplary matrix A.

### Task Optimization:

| | Energy | Latency | Task Accuracy |
|---|---|---|---|
| Energy | 1 | ⅓ | ⅕ |
| Latency | 3 | 1 | ⅓ |
| Task Accuracy | 5 | 3 | 1 |

In this example, the following values apply:
Maximum eigenvalue λ: 3.039
Eigenvector: [0.15 0.37 0.92]
Normalized rewards: [0.15 0.37 0.92]/sum[0.15 0.37 0.92]
   Eigenvector corresponding to the maximum eigenvalue λ

| | Eigenvectors | Normalized Rewards |
|---|---|---|
| Energy | 0.15 | 0.1 |
| Latency | 0.37 | 0.26 |
| Task Accuracy | 0.92 | 0.64 |

The inconsistency value is (3.039−3)/(3−1)=0.020 (<0.1)

The above case shows the reward weights provided to the agent when the task accuracy is the metric to be optimized.

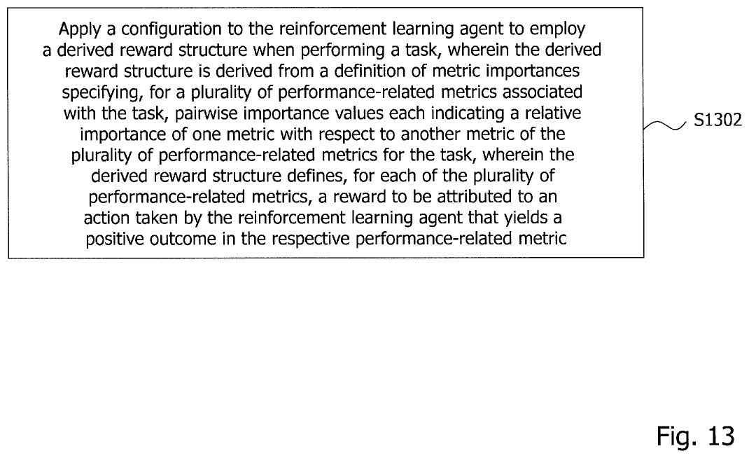

FIG. 13 illustrates a method which may be performed by the reinforcement learning agent executed on the computing unit 110 according to the present disclosure. The method is dedicated to configuring the reinforcement learning agent to perform a task using a reward structure derived from a task-specific definition of metric importances. The operation of the reinforcement learning agent may be complementary to the operation of the configurator component described above and, as such, aspects described above with regard to the operation of the reinforcement learning agent may be applicable to the operation of the reinforcement learning agent described in the following as well. Unnecessary repetitions are thus omitted in the following. In step S1302, the reinforcement learning agent may apply a configuration to the reinforcement learning agent to employ a derived reward structure when performing the task, wherein the derived reward structure is derived from a definition of metric importances specifying, for a plurality of performance-related metrics associated with the task, pairwise importance values each indicating a relative importance of one metric with respect to another metric of the plurality of performance-related metrics for the task, wherein the derived reward structure defines, for each of the plurality of performance-related metrics, a reward to be attributed to an action taken by the reinforcement learning agent that yields a positive outcome in the respective performance-related metric.

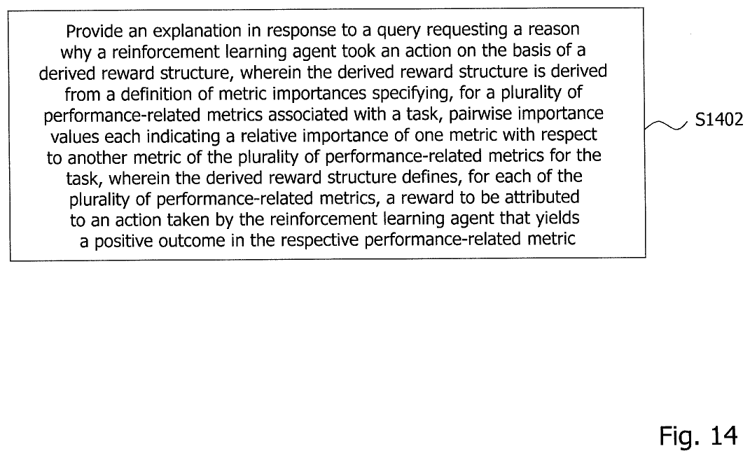

FIG. 14 illustrates a method which may be performed by the explainer component executed on the computing unit 120 according to the present disclosure. The method is dedicated to explaining an action performed by a reinforcement learning agent performing a task using a reward structure derived from a task-specific definition of metric importances. The operation of the explainer component may be complementary to the operation of the configurator component and/or the reinforcement learning agent described above and, as such, aspects described above with regard to the operation of the explainer component may be applicable to the operation of the explainer component described in the following as well. Unnecessary repetitions are thus omitted in the following. In step S1402, the explainer component may provide an explanation in response to a query requesting a reason why the reinforcement learning agent took an action on the basis of a derived reward structure, wherein the derived reward structure is derived from a definition of metric importances specifying, for a plurality of performance-related metrics associated with the task, pairwise importance values each indicating a relative importance of one metric with respect to another metric of the plurality of performance-related metrics for the task, wherein the derived reward structure defines, for each of the plurality of performance-related metrics, a reward to be attributed to an action taken by the reinforcement learning agent that yields a positive outcome in the respective performance-related metric.

As has become apparent from the above, the present disclosure provides a technique for configuring a reinforcement learning agent to perform a task using a reward structure derived from a task-specific definition of metric importances. While traditional reinforcement learning techniques may make use of reward engineering in an ad-hoc way, the technique presented herein may use multi-criteria decision-making techniques to extract relative weights for multiple performance-related metrics associated with the task to be performed. The presented technique may as such provide a reward engineering process that takes into account stakeholder preferences in a consistent manner, which may prevent reinforcement learning algorithms from converging to suboptimal reward functions or requiring exhaustive search. Zones may be specified within which certain features may be of primary importance and may have to be consistently reflected in the reward structure. By the use of consistent transformations, consistent rewards that are to be automatically focused on in various deployment zones may be specified and, also, a consistent hierarchical model may be accomplished which enables providing superior quality explanations to stakeholder queries.

In other words, the technique presented herein may provide a consistent methodology for reinforcement learning reward engineering that may capture the relative importance of metrics in particular zones. The technique may overcome deficiencies in traditional reinforcement learning techniques suffering from inconsistent valuation of rewards. Explanations may be incorporated as artifacts in the evaluation which may ensure that other metrics are not skewed. Utilizing consistent metrics as a basis for explanations may assist the stakeholder to understand the explanations and to provide feedback refining the agent. Agents may be specialized to work in zones taking into account the critical weighted features for the optimization of rewards. Also, agents may be allowed to prioritize different aspects while maintaining a consistent reward value.

It is believed that the advantages of the technique presented herein will be fully understood from the foregoing description, and it will be apparent that various changes may be made in the form, constructions and arrangement of the exemplary aspects thereof without departing from the scope of the invention or without sacrificing all of its advantageous effects. Because the technique presented herein can be varied in many ways, it will be recognized that the invention should be limited only by the scope of the claims that follow.

1. A method for configuring a reinforcement learning agent to perform a task using a reward structure derived from a task-specific definition of metric importances, the method being performed by a computing unit executing a configurator component and comprising:
obtaining a definition of metric importances specifying, for a plurality of performance-related metrics associated with the task, pairwise importance values each indicating a relative importance of one metric with respect to another metric of the plurality of performance-related metrics for the task;
deriving a reward structure from the definition of metric importances, the reward structure defining, for each of the plurality of performance-related metrics, a reward to be attributed to an action taken by the reinforcement learning agent that yields a positive outcome in the respective performance-related metric; and
configuring the reinforcement learning agent to employ the derived reward structure when performing the task.

2. The method of claim 1, wherein deriving the reward structure from the definition of metric importances is performed using a multi-criteria decision-making, MCDM, technique.

3. The method of claim 1 or 2, wherein the definition of metric importances is provided as a matrix A:
$$\begin{matrix}{A}_{1} \\ ⋮ \\ {A}_{n}\end{matrix} {[ \begin{matrix}{w}_{11} & … & {w}_{1 n} \\ ⋮ & ⋱ & ⋮ \\ {w}_{n 1} & … & {w}_{nn}\end{matrix} ]}^{\begin{matrix}{A}_{1} & … & {A}_{n}\end{matrix}}$$
where n is the number of metrics of the plurality of performance-related metrics and wᵢⱼ is the pairwise importance value indicating the relative importance of metric Aᵢ with respect to metric Aⱼ, where i=1, . . . , n and j=1, . . . , n.

4. The method of claim 3, wherein deriving the reward structure from the matrix A includes solving the eigenvalue problem Aw=λw:
$$[ \begin{matrix}{w}_{11} & … & {w}_{1 n} \\ ⋮ & ⋱ & ⋮ \\ {w}_{n 1} & … & {w}_{nn}\end{matrix} ] [ \begin{matrix}{w}_{1} \\ ⋮ \\ {w}_{n}\end{matrix} ] = λ [ \begin{matrix}{w}_{1} \\ ⋮ \\ {w}_{n}\end{matrix} ]$$
where λ is the maximum eigenvalue of A and w=[w₁ . . . wₙ] is the solution of the eigenvalue problem, wherein each weight wᵢ is taken as the reward for the corresponding metric Aᵢ, where i=1, . . . , n.

5. The method of claim 5, wherein w=[w₁ . . . wₙ] is normalized by dividing each weight wᵢ by the sum of the weights w₁ . . . wₙ, where i=1, . . . , n.

6. The method of claim 3, wherein the matrix A is a positive reciprocal matrix.

7. The method of claim 4, wherein deriving the reward structure from the matrix A includes performing a consistency check of the matrix A using, as a measure of deviation of the matrix A from consistency, an inconsistency value defined by:
$$\frac{λ - n}{n - 1}$$

8. The method of claim 7, wherein, if the inconsistency value is above a predefined threshold, deriving the reward structure from the matrix A includes identifying, among the pairwise importance values wᵢⱼ of the matrix A, one or more entries causing inconsistency and perturbing the one or more entries to reduce the inconsistency.

9. The method of claim 8, wherein identifying and perturbing one or more entries causing inconsistency is iteratively performed until the inconsistency value is below the predefined threshold.

10. The method of claim 7, wherein, if the inconsistency value is above a predefined threshold, deriving the reward structure from the matrix A includes reconstructing the matrix A based on a set of distinct eigenvalues λ₁, . . . , λₙ and corresponding linearly independent eigenvectors v₁, . . . , vₙ, wherein the matrix A is reconstructed as
A=PDP⁻¹
where matrix P is constructed by stacking v₁, . . . , vₙ as column vectors and matrix D is D=(λ₁, . . . , λₙ).

11. The method of claim 1, wherein the definition of metric importances is derived from a requirements specification regarding the task to be performed by the reinforcement learning agent.

12. The method of claim 11, wherein the requirements specification is formulated using a formal requirements specification syntax, optionally an Easy Approach to Requirements Syntax, EARS, wherein at least portions of the requirements specification are pattern matched to derive the definition of metric importances.

13. The method of claim 1, wherein an explanation provided in response to a query requesting a reason why the reinforcement learning agent took a particular action is provided on the basis of the derived reward structure.

14. The method of claim 13, wherein the explanation is provided with reference to a formulation of a requirements specification regarding the task to be performed by the reinforcement learning agent, and optionally indicating that the particular action was taken in order to meet the formulation of the requirements specification.

15. The method of claim 1, wherein the reinforcement learning agent is operable to perform the task in a plurality of deployment setups, wherein, for each of the plurality of deployment setups, a different definition of metric importances specific to the respective deployment setup is obtained and used to derive a different reward structure specific to the respective deployment setup, wherein the reinforcement learning agent is configured to employ one of the different reward structures depending on the deployment setup in which the reinforcement learning agent currently operates.

16. The method of claim 15, wherein, when an operation of the reinforcement learning agent is changed to a different deployment setup, the reinforcement learning agent is automatically reconfigured to employ the different reward structure that corresponds to the different deployment setup.

17. The method of claim 1, wherein the task to be performed by the reinforcement learning agent includes determining a network slice configuration for a mobile communication network, wherein, optionally, the plurality of performance-related metrics comprises at least one of a latency observed for a network slice, a throughput observed for a network slice, an elasticity for reconfiguring a network slice, and an explainability regarding a reconfiguration of a network slice.

18. The method of claim 1, wherein the task to be performed by the reinforcement learning agent includes operating a robot, wherein, optionally, the plurality of performance-related metrics comprises at least one of an energy consumption of the robot, a movement accuracy of the robot, a movement speed of the robot, and a safety level provided by the robot.

19. The method of claim 1, wherein the task to be performed by the reinforcement learning agent includes determining an antenna tilt configuration for one or more base stations of a mobile communication network, wherein, optionally, the plurality of performance-related metrics comprises at least one of a coverage achieved by the antenna tilt configuration, a capacity achieved by the antenna tilt configuration, and an interference level caused by the antenna tilt configuration.

20. The method of claim 1, wherein the task to be performed by the reinforcement learning agent includes determining an offloading level for offloading of computational tasks of one computing device to one or more networked computing devices, wherein, optionally, the plurality of performance-related metrics comprises at least one of an energy consumption of the computing device, a latency observed by the computing device of receiving results of the computational tasks offloaded to the one or more networked computing devices, and a task accuracy achieved by the computing device when offloading the computational tasks to the one or more networked computing devices.

21.-28. (canceled)
